(19) United States
(12) Patent Application Publication
(10) Pub. No.: US 2010/0158494 A1
(43) Pub. Date: Jun. 24, 2010

(54) Radio Wireless Mesh Network System and Method for Photographic Camera Integration

(75) Inventor: Kevin James King, Vancouver, WA (US)

Correspondence Address: Leap Devices, LLC, Suite 100, 501 SE Columbia Shores Blvd, Vancouver, WA, 98661, US

(73) Assignee: Leap Devices, LLC

(21) Appl. No.: 12/632,792

(22) Filed: Dec. 7, 2009

Related U.S. Application Data
(60) Provisional application No. 61/120,467, filed on Dec. 7, 2008.

(51) Int. Cl. G03B 17/00

(52) U.S. Cl. 396/56

(57) ABSTRACT

Methods and by which photographic equipment having a wireless communication functionality may join a wireless personal area network which may be a mesh network. In various representative embodiments a photographic device may discover the existence of a wireless personal area network and may provide an indication to a node of the personal area network of its existence and thus a coordinator node or node of a personal area network may discover the photographic device. Methods by which specific events which must be substantially synchronized in time may be synchronized by information or data comprised in a superframe of a transmission of a node of a wireless personal area network.

### CROSS REFERENCES TO RELATED APPLICATIONS

This application claims the benefit of U.S. Provisional Patent Application No. 61/120,467 filed Dec. 7, 2008, and incorporates the disclosure of that application by reference.

### SUMMARY OF THE INVENTION

In various representative aspects, the present invention includes a radio transmitter which may also be capable of receiving radio signals (“transceiver”) which may be coupled to or integral to a photographic device, wherein said transceiver may be managed by a processing capability which may enable said transceiver to communicate with one or more additional transceivers which may comprise a mesh network.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a simplified block diagram of a radio module;

FIG. 2 representatively illustrates a front view of a camera coupled to an exemplary communication device having a radio module;

FIG. 3 representatively illustrates a perspective view of a flash device coupled to an exemplary communication device having a radio module;

FIG. 4 representatively illustrates a diagram of an exemplary wireless personal area network;

FIG. 5 representatively illustrates a simplified block diagram of a superframe which may be transmitted between nodes of a wireless personal area network;

FIG. 6 representatively illustrates a simplified diagram of a star typology of a wireless personal area network or wireless mesh network;

FIG. 7 representatively illustrates a simplified diagram of a peer to peer typology of a wireless personal area network or wireless mesh network.

Elements and steps in the figures may be illustrated for simplicity and clarity and have not necessarily been rendered according to any particular sequence. For example, steps that may be performed concurrently or in different order may be illustrated in the figures to help improve understanding of embodiments of the present invention.

### BACKGROUND OF PRIOR ART AND EXISTING CHALLENGES

Currently in the field of photography, there is a need to allow various devices which may be used in the field of photography to communicate wirelessly with one another. Various prior art solutions and devices exist which may enable a camera or any example of another photographic device (which may be another camera, a lighting device, a communication device, a personal computer, etc) to communicate various signals via various wireless methods in one direction or in both directions. These wireless signals may allow the control of one photographic device from another photographic device.

Prior art solutions are however limited in that two or more photographic devices may be required to be specifically configured in such a way so as to allow the communication between devices to take place. For example, a user, which may be a photographer, may be required to set the same radio frequency and/or a radio channel to each device which will send and/or receive wireless signals so that the two or more devices may be able to communicate wireless signals. Furthermore, in certain situations with certain configurations of photographic devices, it may be desired or even required that a given photographic device be aware of the existence of one or more additional photographic devices, wherein no physical electrical connection may exist between the given photographic device and the one or more additional photographic devices. A user may be required to manually configure a given photographic device to specific settings or modes which may denote the presence of additional photographic devices, the number of additional photographic devices, the capabilities of said additional photographic device(s), and possibly even the current mode or setting of said additional photographic device(s).

Some prior art technology may allow multiple wireless communication devices to be able to communicate instructions specifically from one device to another device based on a unique identification number of each device, whereby a transmitting device may transmit using an identification number to a specific receiving device having the same identification number and wherein the receiving device may only process instructions from a transmitting device having a specific identification number. This method is limited in that it may not provide a means to coordinate communications between devices in an efficient manor, and may require a human user to enter identification numbers of devices manually. Moreover, this method complicates the operation of integrating new devices into the group of communicating devices. Moreover, it may be complicated to manage identification numbers such that the numbers are always unique. The present invention may provide a method of grouping devices based on an identification of the group or network, and to allow devices to enter or participate in a given network, and to allow devices to be authorized into a group or network based on the identification of the network rather than the identification of individual devices.

Moreover, problems may exist when a photographer is working with one or more photographic devices which may be communicating wirelessly if one or more photographic devices become non-responsive, generate an error condition, become placed a physical distance too far away to carry on reliable wireless communications, etc. A photographer may have an indication that a photographic device failed to operate only after seeing the resulting image and noting that for example, a lighting device failed to operate, or operated with an incorrect power level, etc. In an example where an event being photographed happens quickly or only one time, the photographer may not achieve an acceptable image of the event.

Moreover, the implementation of wireless communications in the field of photography may be challenging as camera systems may require extreme low latency communication with other devices to synchronize the timing of events such as the activation of a camera shutter with the activation of a lighting device, or observing a reading from a light meter in synchronization with the activation of a lighting device, etc. For this reason, prior art wireless communication devices intended for use in the field of photography may incorporate various proprietary signaling means which may be of sufficiently short duration as to carry out the required synchronization of various events, wherein the requirement of high speed low latency communication may require a less robust or less reliable method of wireless signaling to be implemented. Moreover, there may be no assurance of a complete and/or accurate communication of wireless signals between one or more photographic devices during a communication event or sequence of communication events which may be carried out by various photographic devices during the process of capturing one or more photographic images.

In various representative aspects, the present invention may solve these challenges and others that may be faced when implementing wireless communication between various photographic devices.

### Summary of Device Having Mesh Networking Capability

The present invention may be described herein in terms of functional block components and various processing steps. Such functional blocks may be realized by any number of hardware or software components configured to perform the specific functions and achieve the various results. For example, the present invention may employ various cameras, flash devices, radio transmitters, radio receivers, as well as any software to provide functionality and interconnectivity between such cameras, flash devices, radio transmitters, and radio receivers.

A photographic device may comprise any example of a device having useful functionality and/or application in the field of photography and may include but may not be limited to cameras, flash devices, wireless networking devices, personal computing devices, image printing devices, devices used to display images such as projectors, digital picture frames, etc.

In accordance with various exemplary embodiments, cameras for example, may comprise any of still and/or video graphic devices that may capture images in any manner, for example digitally, by film, or any other manner now known or developed in the future that may benefit from the present invention. The present invention may further employ various flash devices, for example, wireless flash devices, strobe light devices, synchronous flash devices, hardwired flash devices, etc. Exemplary flash devices may comprise a single flash device, a plurality of flash devices, coordinated flash devices, various light frequency flash devices, integral flash devices, and the like. Exemplary flash devices may provide flashes comprising various intensity, duration, timing, color, etc. With respect to radio transmitter and radio receivers, the present invention may employ any now known or future developed transmitter/receiver components, and the radio transmitters and receivers may be configured to operate over a single radio frequency, multiple radio frequencies, as well as any other electromagnetic frequency outside of the typical “radio” band. The transmitter/receiver components may function on any one or combination of wavelength, wave type (square wave, s-wave, etc.), amplitude, modulation, frequency deviation, frequency bandwidth, period, power, range, and any other like electromagnetic wave characteristics. Moreover, the radio transmitter may also comprise radio receiving capabilities and may be termed “radio transceiver” or “transceiver” capable of both sending and receiving radio signals, and similarly the radio receiver may also comprise radio transmission capabilities and may be termed “radio transceiver” or “transceiver” capable of both receiving and sending radio signals.

Thus, the various components may carry out a variety of functions, and in addition, the present invention may be practiced among any number of general environments, for example, still photography, video graphy, high speed photography, portrait imaging, landscape imaging, etc. The system described may be merely one exemplary application for the invention, and the present invention may employ any number of conventional techniques for coordinating a remote flash device and a camera.

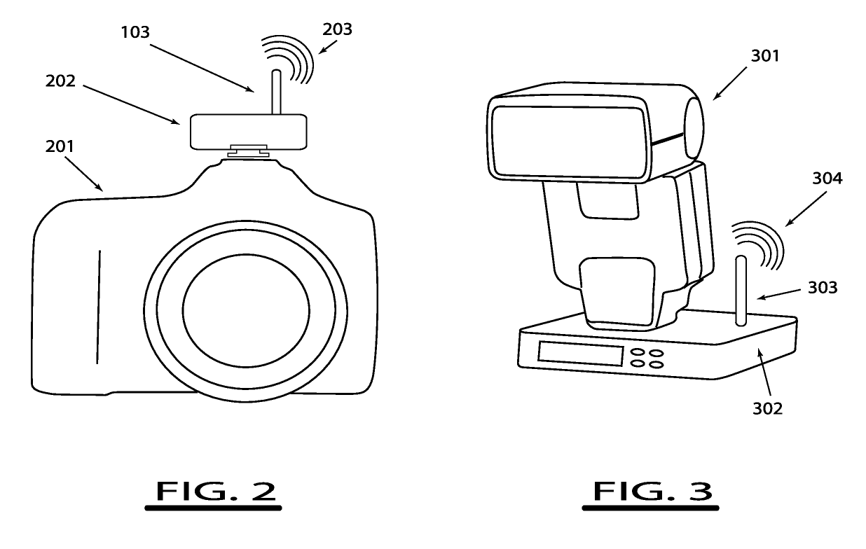

As illustrated in FIG. 2 and FIG. 3, various representative implementations of the present invention may be applied to any system for a camera 201 to communicate with an intermediate device such as a communication module 202 which may comprise a radio transceiver which may further communicate via radio signals 203 from an antenna element 103 with a remote flash device, another camera, a photographic device, etc, via a radio transceiver comprised within a remote flash device (not pictured), another camera (not pictured), a photographic device (not pictured), etc, or via an intermediate device such as a communication module 302 which may comprise a radio transceiver and an antenna element 303 for receiving radio signals 304, wherein the communication module 302 may be coupled to a flash device 301; and may be applied to any system for a camera comprising a radio transceiver which may communicate with a remote flash device, another camera, a photographic device, etc. In any embodiment, an apparatus comprising a radio transceiver which is coupled to a photographic device, or a photographic device comprising a radio transceiver may be able to carry out the useful functionality of the present invention.

It is considered by the present invention that various other devices which may comprise a radio transceiver may also control, be controlled, or participate in a wireless communication with a camera, a flash device, photographic device, etc.

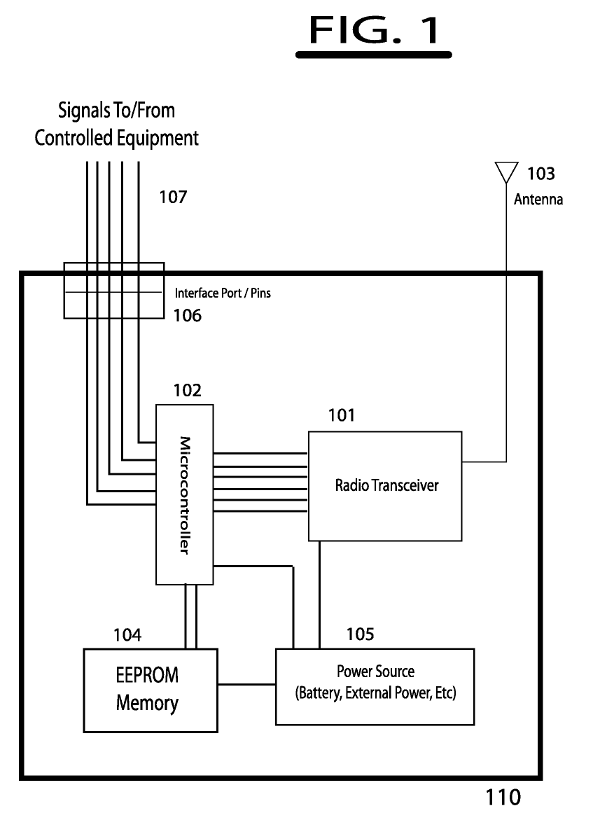

In accordance with an exemplary embodiment and as may be illustrated as a simplified block diagram of FIG. 1, the present invention may comprise a radio transceiver 101 which may be electrically coupled to a processing means such as a microprocessor (“MCU”) 102 which may have any combination of a volatile memory, a non-volatile memory 104 such as an EEPROM or similar memory, and a software or “firmware” which may control or otherwise coordinate the sending and/or receiving of radio signals to or from a radio transceiver 101, and which may control or otherwise coordinate the sending and/or receiving of various signals and/or data to one or more photographic device(s) 107 which may be electrically connected to or otherwise perceptible of an MCU. A “radio module” 110 may comprise any example or combination of a radio transceiver 101, one or more antenna element(s) 103 suitable for sending and/or receiving radio signals, an MCU 102, a firmware, and an appropriate power source 105 for powering the MCU, radio transceiver, antenna element(s), as well as any memory 104 or associated required or optional circuitry which may enable or support the operation of a radio module. A radio module may have a connector or port or terminal 106 used to electrically connect signals from an MCU 102 of a radio module 110 to external equipment which may be controlled equipment which may be any example of photographic equipment. An MCU of a radio module may perform other tasks beyond the scope of the present invention, or similarly, an MCU intended primary to carry out other tasks beyond the scope of the present invention may also be used as an MCU of a radio module. For example, an MCU of a camera which may acquire and/or process an image captured by a digital imaging sensor may also comprise appropriate electrical connections to a radio transceiver and may also comprise a firmware or portion of firmware which may control, be controlled by, or otherwise interact with a radio transceiver. A radio module may comprise various components such as a radio transceiver, antenna element(s), MCU, memory, power source, etc, as a single chip or integrated circuit (“IC”), or as a plurality of IC's which are appropriately electrically connected, or as various discrete electronic components which may be appropriately electrically connected, or in any combination or sequence thereof.

A “software stack” may comprise firmware of an MCU or portion of a firmware of an MCU of a radio module and may comprise a logical process or set of logical processes, a program, or a set of programs that may work together to produce a result, or may work in sequence or individually or as a group to produce a result, or cause the enablement of a desired functionality of a radio module.

In accordance with an exemplary embodiment, the present invention may comprise a radio module which may comprise a software stack which may enable the radio module to participate in a wireless mesh network. An example of mesh networking may be described by the IEEE 802.15.4 (IEEE may denote Institute of Electrical and Electronics Engineers) specification. The standard of “IEEE 802.15.4-2003”, available from the IEEE 802.15 working group, as well as the standard “IEEE 802.15.4-2006”, also available from the IEEE 802.15 working group are incorporated in their respective entirety in this specification for reference. A “mesh protocol” may comprise any sequence or process which may be carried out by a radio module which may be based on IEEE 802.15.4, or any process, protocol, or technology based on IEEE 802.15.4, or any process, protocol, or technology which may be proprietary which may enable similar useful functionality of a radio module and may provide some or all of the useful functionality and/or advantage of a wireless mesh network based on IEEE 802.15.4. A mesh protocol does not necessarily need to enable all of the useful functionality and/or advantage as that specified by IEEE 802.15.4 or any of the processes, protocols, or technologies which may be based there upon.

A “wireless mesh network” may comprise one or more devices which may be capable of communicating via radio signals via radio module(s) and wherein each device may comprise a “node”. Two or more nodes may comprise a “personal area network” (“PAN”) or “wireless personal area network” (“WPAN”). A node may be a Full Function Device (“FFD”), or a Reduced Function Device (“RFD”), and wherein an FFD may be able to act as a “coordinator” of the WPAN, and an FFD may be able to act as an “end device” of the WPAN. An FFD may be able to route information between two or more nodes of the WPAN other than itself. An RFD may not be able to route information between nodes, and an RFD may not be able to act as a coordinator of the WPAN, and an RFD may be able to act as an end device of the WPAN. A coordinator of a WPAN which may be an FFD, and may maintain a PAN Information Database (“PIB”). The PIB may comprise a collection of data which may relate to various parameters of other nodes of the PAN or WPAN.

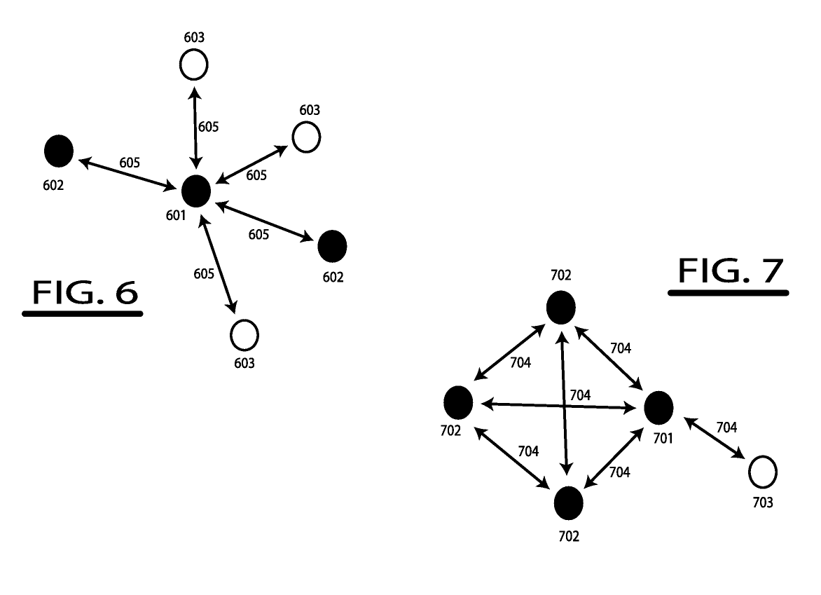

An illustrative example of a wireless mesh network of a “star typology” may be depicted in FIG. 6, and an illustrative example of a wireless mesh network of a “peer to peer typology” may be depicted in FIG. 7. In FIG. 6, which may depict a star typology WPAN, a coordinator node 601 may communicate wirelessly 605 by sending and/or receiving radio signals from other devices 602 that may be FFD's, and may also communicate wirelessly 605 by sending and/or receiving radio signals from other devices 602 that may be RFD's. It is possible that a single WPAN having a star typology may be also considered a “mesh cluster”. It may be possible for one or more nodes of a mesh cluster to also communicate with a node of another mesh cluster which may be physically located within radio signal range of the first mesh cluster, and thus, the various nodes of the first mesh cluster may be able to communicate with the various nodes of the second mesh cluster. In FIG. 7, which may depict a peer to peer typology WPAN, a coordinator node 701 may be present but may not necessarily need to be present. A coordinator node which may be an FFD may also communicate wirelessly 704 with various other FFD's 702 as well as other RFD's 703. It may be possible also for various FFD's 702 and/or RFD's 703 to communicate wirelessly 704 directly with one another, and may not necessarily require the involvement of a coordinator node 701.

The various nodes of a PAN, WPAN, or wireless mesh network may communicate through various structured or non-structured communication methods and/or formats. Two of these methods may be a “beacon mode” and a “non-beacon mode”. It is possible also that various nodes may communicate wirelessly also using various proprietary methods or via methods that are not associated with any specification of a mesh network. In a non-beacon mode, a given first node of a WPAN may begin receiving radio signals (a radio receive mode, or “listen” mode) continually while waiting for another second node of a WPAN to begin transmitting radio signals (a radio transmit mode, or “talk” mode) to which the first node may be responsive. Alternately, a given first node of a WPAN may periodically alternate between a listen mode and a lower power “sleep” mode during which time the node may not be able to receive radio signals. In a beacon mode of a WPAN, a coordinator node may transmit a set of radio signals which may comprise a beacon at a regular or predictable interval of time.

The various nodes of a WPAN wireless mesh network may communicate during regular predictable periods of time, wherein the start of a given period of time may be denoted by the transmission of a “beacon” 502 by a node of the WPAN which may also be the coordinator node of the WPAN.

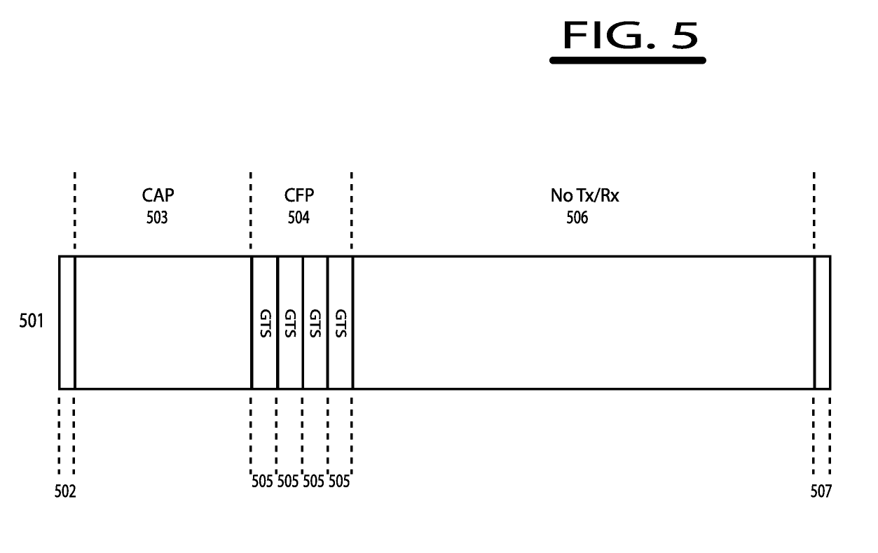

In a beacon mode, some or all communications between various nodes of the WPAN may be timed to be somewhat or substantially synchronized to the occurrence of a coordinator node of the WPAN transmitting a beacon. The interval of time between the start of one beacon transmission and the start of the subsequent beacon transmission may be a “superframe”. A superframe 501 may be illustratively depicted in FIG. 5. The superframe 501 may be logically separated into different intervals of time. The superframe 501 may begin with a beacon 502, followed by a Contention Access Period (“CAP”) 503, followed by a Contention Free Period (“CPF”) 504, followed by a period of inactivity 506 during which time no radio signals may be transmitted or received. A subsequent superframe may begin some period of time later as another beacon 507 may be transmitted by a coordinator node of the WPAN. The CFP 504 may be further subdivided into one or more Guaranteed Time Slot(s) (“GTS”) 505. It is possible that one or more nodes may still communicate radio signals during the inactive period 506. During the CAP period 503, various nodes of the WPAN may communicate wirelessly using a carrier sense multiple access with collision avoidance (“CSMA-CA”) method, wherein various nodes may listen to a radio frequency for another transmission before performing its own transmission, this may be known as a Clear Channel Assessment (“CCA”). There may be some latency of communications during the CAP period because one node may have to wait for another node to complete a communication before making its own communication. During the CFP period, a GTS may be a period of time during which only two nodes are permitted to carry out a communication, and wherein other nodes will not transmit radio signals. A GTS period 505 may start at a substantially precise point of time in relation to the point in time of the transmission of a beacon 502.

A beacon 502 may comprise a variety of information useful to the WPAN and/or the nodes of the WPAN such as but not limited to, an identification specific to the given WPAN or mesh cluster, notifications to various nodes of messages or data destined for the various nodes, as well as the assignment of GTS's 505 to specific nodes to carry out a communication, as well as other parameters or information useful or essential to the continued operation of the WPAN.

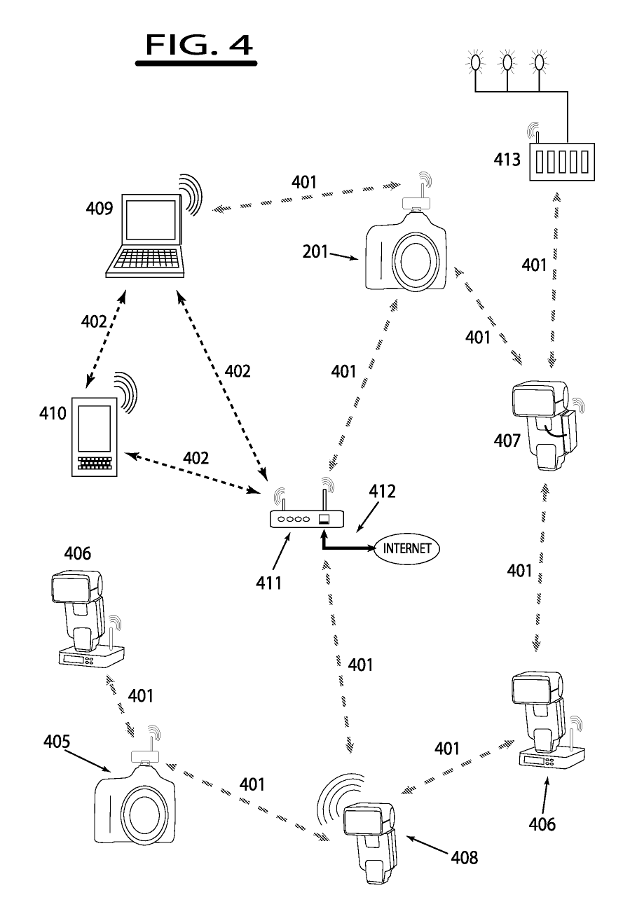

An example of a WPAN may be illustratively depicted in FIG. 4 and briefly described as follows. Various devices such as cameras 201, 405, which may comprise or be coupled to a radio module which may be a node of a WPAN may communicate with various other devices which may comprise or be coupled to a radio module which may also be a node of a WPAN such as flash devices 407, 406, 408, 406. Communication via wireless radio signals 401 may be carried out directly between two nodes or may be routed through nodes. Additionally, a node may communicate via wireless radio signals with an access point 411 which may be able to transmit or receive radio signals of the mesh protocol used by the other nodes. An access point 411 may provide access to another network 412, local area network, or the global internet such that communications of the WPAN may also be routed to or from external networks. An access point 411 or a communication device of a camera may provide additional capability of transmitting radio signals using another protocol which may or may not be a mesh protocol, for example, a BlueTooth protocol 402 which may enable communication between various nodes of the WPAN with other devices such as personal computers 409, personal digital assistants 410, and the like. Additionally, a node of a WPAN which may be compatible with a commercial specification or standard such as but not limited to ZigBee may be able to communicate via a mesh protocol via wireless radio signals 401 with another device 413 such as a lighting control unit which may further control the lighting installed in a building, and thus, various nodes of the WPAN may be able to interact via the another device 413 to query or adjust other parameters of the scene being photographed for example, the ambient light created from overhead lights installed in a building.

Methods Enabled by Present Invention

The present invention may enable various methods to be carried out which may be of novel use to a photographic device or various users of photographic devices when working in the field of photography.

It is a desire in the field of photography to simplify the connection or interaction or configuration of various equipment and/or photographic equipment such that a non-technical user may be able to easily configure various devices and/or photographic equipment to operate together in various configurations.

When a photographic equipment which may comprise a radio module of the present invention or may be coupled to a radio module of the present invention, or may otherwise be perceptible of a radio module of the present invention (hereafter together, in whole, in part, or in any combination thereof “WPAN enabled photographic device”) is powered on, a radio module may begin to listen for a beacon which may be transmitted by a coordinator node of a WPAN. The WPAN enabled photographic device may have a network identification entered by a user, by a manufacturer. The WPAN enabled photographic device may begin listening for a beacon which may be transmitted by a coordinator node of a WPAN which may comprise a network identification of a WPAN matching the network identification of a WPAN entered by a user or by a manufacturer. Alternately or in addition to, the WPAN enabled photographic device may listen for and record the network identification of any beacon(s) which may have been transmitted by any WPAN found and may present the various network identifications discovered to a user who may be able to select which WPAN to join. A WPAN enabled photographic device may automatically or by the interaction of a user attempt to join a given WPAN based on an identification of the WPAN which may have been transmitted by a node of the WPAN.

A first node of a WPAN (which may be a coordinator node of the WPAN) may be able to transmit a communication to a second node of the WPAN wherein the second node of the WPAN may measure a Link Quality Indicator (“LQI”) of the received communication, may provide an acknowledgement (“ACK”) back to the first node of the WPAN and may also provide a communication back to the first node of the WPAN which may comprise a data or value representative of the obtained LQI. Thus, a first node of a WPAN may be aware that a second node of the WPAN is within range of radio signals, and may also have an indication as to the quality of the wireless link between the two nodes. An LQI may be based on any number of parameters including but not limited to the strength of the received signal from the first node which may be measured in dBm or another metric, or may be based on the timing accuracy of digitally modulated symbols of the communication, etc.

In one exemplary embodiment of the present invention, a communication device 202 may be coupled to a camera 201 or comprised within a camera 201 wherein the communication device may comprise a radio module of the present invention and wherein the radio module may be capable of operating as a FFD of a WPAN and may also operate as a coordinator node of a WPAN. The communication device 202 via radio module may begin to transmit a beacon at a regular interval which may comprise an identification of a WPAN, and wherein the communication device via radio module may act as a coordinator node of a WPAN.

A second photographic device which may comprise a second radio module of the present invention which when powered on or as a result of a user interaction may begin to listen for a beacon of a WPAN, and whereupon receiving the beacon at a regular interval which may be transmitted by the communication device 202 may attempt to join the WPAN having the identification of the WPAN transmitted by communication device 202.

Upon a second photographic device joining the WPAN and thus becoming a node of the WPAN, the coordinator node of the WPAN may add a memory of the second photographic device to a PIB of the coordinator node.

The coordinator node may indicate to the second photographic device which may be a node of the WPAN as well as any additional node(s) of the WPAN that the second photographic device and any other node(s) of the WPAN should respond with an ACK. The response of an ACK or any other received communication from any other node of the WPAN may be used as a basis to establish the presence of the second photographic device and any other node(s) of the WPAN. The first photographic device (which may be a communication device 202) may provide an indication to a user or to a camera 201 of the presence of the second photographic device and any other node(s) of the WPAN. The user indication of the presence of the second photographic device and any other node(s) of the WPAN may be regularly updated as subsequent beacons are sent which may require subsequent ACK communications of the various nodes of the WPAN.

The field of photography may require high speed or low latency communications to synchronize time critical events such as but not limited to the synchronized activation of a flash device with the activation of a camera shutter. The duration of a superframe 501 though relatively short may still be sufficiently long to prevent the synchronization of a flash device with a camera shutter, especially when using faster shutter speeds. For this reason, a challenge may be presented in using a wireless mesh networking protocol such as that specified by IEEE 802.15.4 or similar to actually activate various equipment which must be synchronized.

In one exemplary embodiment of the present invention, two or more photographic equipment may synchronize an event using a method as follows. A superframe 501 may comprise a beacon 502, and a beacon 502 may be repeated at a substantially predictable and substantially constant interval of time. It is possible to use the occurrence of a beacon as a marker in time to use as a basis for other events which should be synchronized. For example, a communication which may be a superframe or a portion of a superframe may comprise an instruction for a given node, a group of nodes, all nodes, or any combination thereof to carry out an event a given time following the occurrence of a specific point in the superframe which may be referred to as a “time reference”. A time reference may correspond to the first symbol of a beacon, the last symbol of a beacon, or any other substantially predictable point in time which may be referenced relative to the occurrence of a beacon. In such an example, a shutter of a camera may be activated, and a lighting device may be activated each a substantially exact period of time following a time reference which may be substantially relative to the point in time of the occurrence of the transmission of a beacon.

Various methods are considered to synchronize an event of a photographic device which may be coupled to a node of the WPAN having various timing synchronized based on the initiation or beacon of a superframe, or allotted to specific intervals of time within a superframe, for example, a guaranteed time slot of a superframe.

A guaranteed time slot may be reserved in one superframe or in a portion of a superframe, or in all superframes, or any grouping thereof, wherein during said guaranteed time slot is reserved for a node of the WPAN to transmit radio signals which may initiate the occurrence of an event. The event may be carried out immediately, or at the end of the guaranteed time slot, or at any other time which may be referenced to the timing of the beacon of the superframe, a guaranteed time slot of the superframe, or other indicator substantially representative of a point in time of a superframe.

### SUMMARY

In the foregoing specification, the invention has been described with reference to specific exemplary embodiments. Various modifications and changes may be made, however, without departing from the scope of the present invention as set forth in the claims. The specification and figures may be illustrative, rather than restrictive, and modifications may be intended to be included within the scope of the present invention. Accordingly, the scope of the invention should be determined by the claims and their legal equivalents rather than by merely the examples described.

For example, the steps recited in any method or process claims may be executed in any order and may be not limited to the specific order presented in the claims. Additionally, the components and/or elements recited in any apparatus claims may be assembled or otherwise operationally configured in a variety of permutations and may be accordingly not limited to the specific configuration recited in the claims.

Benefits, other advantages and solutions to problems have been described above with regard to particular embodiments; however, any benefit, advantage, solution to a problem or any element that may cause any particular benefit, advantage or solution to occur or to become more pronounced may be not to be construed as critical, required or essential features or components of any or all the claims.

As used herein, the terms “comprise”, “comprises”, “comprising”, “have”, “has”, “having”, “including”, “includes”, “employs”, “employing” or any variation thereof, may be intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

What may be claimed may be:

1. A method of joining a second photographic device having wireless functionality to a wireless personal area network comprising at least a first photographic device having wireless functionality, the method comprising;
a first photographic device electrically connected to a radio module capable of acting as a coordinator of a wireless personal area network;
a second photographic device electrically connected to a radio module capable of becoming a node of a wireless personal area network;
the transmitting of radio signals comprising a beacon from the first photographic device at an interval of time, followed by the first photographic device receiving radio signals for an interval of time;
the second photographic device receiving radio signals until a beacon from the first device is received;
the second photographic device transmitting an acknowledgement to the first photographic device;
the first photographic device receiving an acknowledgement from the second photographic device;
the first photographic device setting an indication of the presence of the second photographic device.

2. The method of claim 1 wherein a beacon from a first photographic device comprises an identification of a wireless personal area network.

3. The method of claim 2 wherein the second photographic device transmits an acknowledgement to a first photographic device in response to receiving a beacon from a first photographic device comprising a specific identification of a personal area network.

4. The method of claim 1 whereupon a first photographic device setting an indication of the presence of a second photographic device provides an indication as to the existence of the second photographic device to a user.

5. The method of claim 1 whereupon a first photographic device setting an indication of the presence of a second photographic device provides an indication as to the existence of the second photographic device to a photographic equipment.

6. The method of claim 1 whereupon a first photographic device setting an indication of the presence of a second photographic device, the first device is made aware of an identification of the second photographic device wherein the identification of the second photographic device is transmitted by radio signals from the second photographic device to the first photographic device during an interval of time when the first photographic device is receiving radio signals.

7. The method of claim 6 wherein the first photographic device is able to transmit radio signals comprising an identification of the second photographic device.

8. The method of claim 7 wherein the first photographic device transmits radio signals comprising an identification of the second photographic device;
and comprising an indication for the second photographic device to respond with an acknowledgement;
the first photographic device receiving radio signals for an interval of time wherein during said interval of time the second photographic device is expected to transmit an acknowledgement.

9. A method of synchronizing the occurrence of an event of a first photographic device having wireless functionality to an occurrence of an event of an at least second photographic device having wireless functionality, the method comprising;
a first photographic device electrically connected to a radio module capable of transmitting radio signals comprising a beacon;
an at least second photographic device electrically connected to a radio module capable of receiving radio signals transmitted from the a first photographic device;
an at least second photographic device receiving radio signals comprising a beacon transmitted from the a first photographic device;
an at least second photographic device initiating the occurrence of an event a substantially specific interval of time following a substantially specific portion of a beacon.

10. The method of claim 9 wherein an event of a first photographic device is the operation of a shutter of a camera.

11. The method of claim 9 wherein the event of an at least second photographic device is the activation of a flash device.

12. The method of claim 9 wherein a beacon is comprised within a superframe; and wherein a superframe comprises an indication that an event of the a first photographic device is expected to take place a substantially specific interval of time following a substantially specific beacon.

13. The method of claim 12 wherein the a substantially specific interval of time corresponds substantially to a guaranteed time slot of a superframe.

14. The method of claim 9 wherein the a substantially specific portion of a beacon corresponds to the most recent beacon to have been received by the at least second photographic device.

15. The method of claim 9 wherein the a substantially specific portion of a beacon corresponds to a beacon expected to be received by the at least second photographic device sometime in the future.

16. A method of synchronizing the occurrence of an event of a first photographic device having wireless functionality to an occurrence of an event of an at least second photographic device having wireless functionality, the method comprising;
a first photographic device electrically connected to a radio module capable of transmitting radio signals comprising a superframe of a wireless personal area network;
an at least second photographic device electrically connected to a radio module capable of receiving radio signals transmitted from the radio module electrically connected to the a first photographic device;
an at least second photographic device receiving radio signals comprising a superframe of a wireless personal area network transmitted from the radio module electrically connected to the a first photographic device;
an at least second photographic device receiving radio signals during the interval of time corresponding to a guaranteed time slot of a superframe;
the occurrence of an event of the at least second photographic device being based on radio signals received during the interval of time corresponding to a guaranteed time slot of a superframe.

17. The method of claim 16 wherein the event of the at least second photographic device is the activation of a flash device.

18. The method of claim 16 wherein the specific guaranteed time slot of a superframe is reserved by a coordinator node of a wireless mesh network wherein transmitting of radio signals is only permitted by one node of a wireless personal area network during the specific guaranteed time slot.

19. The method of claim 18 wherein the transmitting of radio signals by the one node of a wireless personal area network are expected to comprise radio signals which indicate whether or not an event should occur.

20. The method of claim 16 wherein a specific guaranteed time slot of a superframe is reserved for the transmitting of radio signals which comprise an indication that an event should occur.
